(19) United States
(12) Patent Application Publication
(10) Pub. No.: US 2005/0098504 A1
(43) Pub. Date: May 12, 2005

(54) Oil and gas well fracturing (frac) water treatment process

(75) Inventors: David Harold Manz, Calgary (CA); Tariq Mahmood, Calgary (CA); Hamida Azhar Khanam, Calgary (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Davnor Water Treatment Technologies Ltd., Calgary (CA)

(21) Appl. No.: 10/947,226

(22) Filed: Sep. 23, 2004

Related U.S. Application Data
(63) Continuation-in-part of application No. 10/316,068, filed on Dec. 11, 2002, now abandoned.

(51) Int. Cl. C02F 1/52

(52) U.S. Cl. 210/721; 210/724

(57) ABSTRACT

This invention relates to a novel process for treating and removing undesirable impurities from oil and gas well fracturing fluid. A method for treating fracturing water comprising: (a) passing contaminated fracturing water containing solids and liquid through a mechanical separator to remove solids from the liquid; (b) treating the fracturing water liquid with an alkaline agent to increase the pH of the liquid to a level of above 9; (c)) adding a coagulant to the fracturing water to form an agglomerate and separating the agglomerate from the fracturing water; (d) reducing the pH of the fracturing water of step (c)) to a level of less than about 5.5; and (e) adding an oxidizing agent to the fracturing water of step (d) to oxidize oxidizable impurities in the fracturing water.

This is a continuation-in-part of application Ser. No. 10/316/608, filed Dec. 11, 2002

### FIELD OF THE INVENTION

This invention relates to a novel process for treating and removing undesirable impurities from reclaimed oil and gas well fracturing fluid and rendering the water suitable for re-use.

### BACKGROUND OF THE INVENTION

Hydraulic fracturing (fracing) is a process applied to drilled oil and gas well holes to improve the ability of fluids (such as oil and gas) to flow from the petroleum and gas bearing formation (target reservoir rock) to the drill hole. Hydraulic fracturing involves injecting high pressure fracturing fluid from the surface into the target reservoir rock, usually with various additives, thereby causing the rock to fracture circumferentially away from the hole. Since the weight of the overlying formations will force the fractures to close once the pressure of the fluid is removed, sand or other grains, known as “proppant”, are introduced into the fractures to keep them open, and help the formation fluid (crude petroleum and natural gas) to flow to the drill hole. Once the fracturing process is completed, nearly all of the injected fracturing fluid is recovered during the time the oil and gas flows from the formation into the hole and up to the well surface. Oil and gas well fracturing is often necessary for economical well production.

The fluids used in hydraulic fracturing vary from pure water to gummy gells. Pure “water fracs” do not contain environmentally hazardous substances. Other frac treatments contain various substances to improve the flow characteristics and effectiveness of the frac fluid in fracturing the rock formation. Some frac additives are toxic and may not be suitable for treatment in active aquifers, but most additives are not toxic. All fracture treatments are engineered to limit the frac fluids to the hydrocarbon formation zone being treated.

Common well fracturing additives are listed below. The dosage rates vary with the location and condition of the specific well. These chemicals become an integral part of the frac fluid (blowback water) that is ultimately recovered.

| | |
|---|---|
| Foamers and antifoams | Surfactants |
| Gellants and gel breakers | Viscosifiers |
| Emulsifiers and de-emulsifiers | Cross linkers |
| Biocides | |

For example, a complete range of oil well fracture additives are commercially available from Baker Hughes, Baker Petrolite Division, Sugar Land, Tex., under a number of trademarks as follows. This list is only representative and not all inclusive.

Oil Based Drilling Fluids Additives

| | |
|---|---|
| Dispersants | DRILLAID 700 |
| Solids Wetting Agents | DRILLAID 701 |
| Emulsifiers | DRILLAID 854 |
| Corrosion Inhibitors | CRONOX 861 |
| | ARCOR 1100 |
| Hydrogen Sulfide Control | HSW 700 |
| Water Based Drilling Fluids | ARDRIL |
| Wellbore Cleanup | CS-1 Downhole Cleaner |
| | CS-4 Rinse Surfactant |
| | CS-5 Conditioning Surfactant |
| Foamers | AQUET 944 Amphoferie Foamy Agent |
| | AQUET TD500K Dullery Foamer |
| Biocides | MAGNACIDE 575 |
| | X-CIDE 102 |
| Bioprocessing Additives | BIOQUEST 1110 |
| (antifoamers/defoamers and | DEMVCSO 1 |
| demulsifiers) | |
| Intermediates | AMINOX 1000 |
| (amine allcoxylates, | ARBREAK 102 |
| demulsifiers, surfactants) | ARSURF 1675 |
| Water Clarifiers | ARKLEAR |

Clearwater Engineered Chemistry, Houston, Tex. also provide a range of hydrocarbon based fracturing fluids, water based fracturing fluids, biocides, foaming agents/surfactants, viscofiers, emulsifiers, cross-linkers, under the trademarks AA-100, BAF-1, FL-100, FL-250HT, FLR-150, NDL-100, Amphoam, CWF-311, NE-70, TF-A1, CAT-Foam, NE 200, HCF 710. This list is not all inclusive.

Fracture fluid volumes can vary from a few hundred gallons to over 100,000 gallons per well. Most of the frac fluid is immediately recovered as blowback water. The nature and composition of this “frac water” is significantly different from normal oil and gas production brines that exist naturally and are obtained from the petroleum bearing formation when the well is completed. With the increasing emphasis by regulatory bodies on minimizing environmental impact, disposing of “frac water” has become a problem, especially if it contains environmentally offensive additives.

U.S. Pat. No. 4,536,293, Babineaux, granted Aug. 20, 1985, discloses a method of treating waste water. The method involves purifying waste water from oil well rigs in order that the water may be suitable for reuse on the rig or disposed of conventionally. The method incorporates a series of aerators and corresponding collection tanks to first aerate and then collect the waste water. In each collection tank, sediment is precipitated to the bottom of the tank permitting the clear water to overflow from the collection tank. A soluble aluminum salt is added to the waste water at an initial stage of aeration in order to coagulate the waste particles within the water and form solid precipitates which then settle to the tank bottom. The clearer water is then passesd through subsequent aerators and sedimentation tanks until ultimately the water may be disposed of without polluting or contaminating the environment.

U.S. Pat. No. 5,093,008, Clifford, granted Mar. 3, 1992, discloses a process and apparatus for recovering reusable water from waste drilling fluid. The process and apparatus involves a concurrent reutilization in an active drilling operation of a storage area, an intermixer for introducing treatment chemicals into the waste drilling fluid and a centrifuge. Flocculation of solids in the waste water is chemically induced as it passes through the intermixing means. The waste drilling fluids is then transferred to the centrifuge where it is separated into solid waste and clear reusable water.

U.S. Pat. No. 6,132,619, Lin et al., granted Oct. 17, 2000, discloses a method of resolving solid/emulsion formed as a result of acidification of oil and gas wells. The method includes the steps of adding an iron-control chemical in an amount sufficient to prevent the formation of insoluble iron compounds and adding a water dispersible emulsion breaker into an amount sufficient to separate the sludge emulsion into clean oil water. Further treatment of the waste water includes utilization of water clarifiers, settling vessels and passing the fluid through a macroreticular resin which results in clarified water. Inorganic metal salts such as alum, aluminum chloride and aluminum chlorohydrates and organic polymers such as acrylic acid based polymers are used in treating the sludge emulsion formed by the acidized wells.

U.S. Pat. No. 4,896,665, Colelli et al., granted Jun. 23, 1990, discloses a treatment agent comprising particulate solid which is added to fluid in amounts exceeding solubility. The excess solid fors a layer of treating agent over the layer of sludge at the bottom of a pit. The treating agent has a density greater than the fluid amount and compresses the sludge under gravity. Lime is used as a treatment agent. Also dolomitic and high calcium lime can be used. pH is increased to about 11. The sludge is mixed with the same agent after the liquid is pumped out.

U.S. Pat. No. 6,110,382, Wiemers et al., granted Aug. 25, 2000, discloses an apparatus that is used in treating effluent from drilling fluids to recover wafer for recycling. The apparatus includes a conduit for conducting flow of effluent and an injection pump which injects polymer material into the flow of drilling fluid. Effluent returning from the well is processed by a shaker to remove heavier solids. A polymer processing and storage unit adds liquid polymer flocculant. A mixing unit is used for processing liquid flocculate into the drilling fluid. A centrifuge is used to remove flocculate and solids. The objective is to maintain neutral pH of 7.

U.S. Pat. No. 4,465,598, Darlington et al., granted Aug. 14, 1984, discloses a treatment for well serving fluids. Completion of well's or well servicing is a different field from fracturing fluids used in oil and gas wells. The method involves use of an oxidizing agent to treat well serving fluid to remove heavy metals from the brine from the well. This produces oxidized heavy metals which are insoluble in H₂O. The solids are then removed by filtering, centrifuging and the like. An elevated pH is preferred—actuated with NaOH, Ca(OH)₂, MgOH, or NH₃OH

### SUMMARY OF INVENTION

The invention is directed to a method for treating reclaimed contaminated oil and gas well fracturing water comprising: (a) passing the contaminated fracturing water containing solids and liquid through a mechanical separator to remove solids from the liquid; (b) treating the resultant liquid with an alkaline agent to increase the pH of the liquid to a level greater than about 9.0; (c) adding a coagulant to the liquid to form an agglomerate and separating the agglomerate from the liquid; (d) reducing the pH of the liquid to a level of less than about 5.5; (e) adding an oxidizing agent to the liquid to oxidize and insolubilize oxidizable impurities in the liquid; and (f) removing the insolubilized impurities from the liquid.

The order of the oxidation and acidification steps (d) and (e) above can be reversed. Hydrated lime and/or caustic soda can be added at step (b) to increase the pH of the fracturing water liquid to a level of above about 9.0. In some cases, the pH can be raised to above about 11. A flocculating agent can be added to the liquid along with the coagulant in step (c). An inorganic acid can be added to the liquid at step (d) to reduce the pH to less than about 5.5.

The liquid that is produced from step (f) can be passed through a sand water filter or a sediment cartridge filter to remove insolubilize impurities in the liquid.

In step (d), the liquid can be neutralized by reducing the pH to about 7.0 instead of less than about 5.5. The order of the neutralization and oxidation steps (d) and (e) can be reversed.

The liquid that remains after coagulated and/or flocculated agglomerate particles are removed after step (c) can be subjected to a second clarification step which can include a second acidification step, followed by an oxidation step.

A coagulant can be added to the liquid during the second clarification step. A flocculate can also be added during the second clarification step. The liquid from the second clarification step can be neutralized before being reused. The water that is produced from the second clarification step can be passed through a sand water filter or a sediment cartridge filter to remove insoluble particles in the liquid.

The fracturing water liquid in step (a) can be oxidized after being mechanically separated and before proceeding to step (b), and in step (d) the pH of the liquid can be reduced to about 7.0 A flocculating agent can be added along with a coagulant in step (c). The alkaline agent can be hydrated lime. The coagulant can be polyaluminum chloride. The inorganic acid can be hydrochloric acid. The oxidizing agent can be potassium permanganate.

### BRIEF DESCRIPTION OF DRAWINGS

In drawings which illustrate specific embodiments of the invention, but which should not be construed as restricting the spirit or scope of the invention in any way:

FIG. 1 illustrates a flow sheet setting out a series of operations according to one aspect of the invention to treat spent frac water so that it is converted to acceptable and reusable water.

### DETAILED DESCRIPTION OF SPECIFIC EMBODIMENTS OF THE INVENTION

The inventors have developed a process to treat reclaimed contaminated frac water to achieve a quality of clarified water suitable for reuse or safe disposal to the environment.

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The process of treating reclaimed contaminated frac water according to the invention involves a number of complex reactions utilizing various chemicals at different stages followed in some cases by a finishing (polishing) treatment. Oil-water-mineral complex suspensions are removed during this process. The synthetic emulsifiers, de-emulsifiers, gellants and metallic cross linkers present in the frac water are suppressed at high respective acidic and alkaline conditions in the presence of de-emulsifiers, coagulants and surfactants. The flocculated particles are removed in a subsequent clarification process.

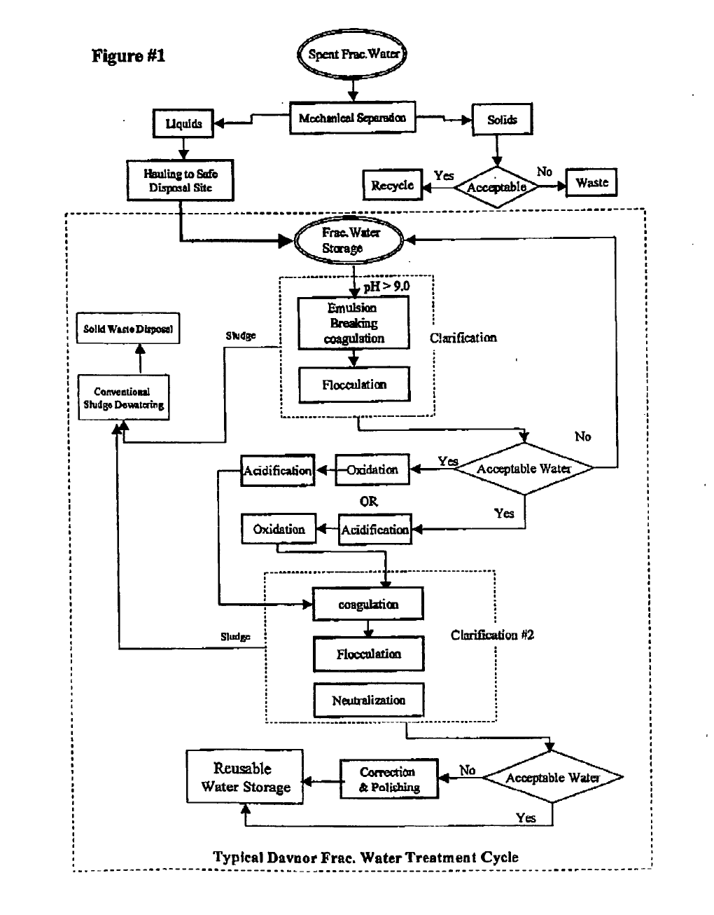

FIG. 1 illustrates a typical set of operations according to the invention that are carried out on spent frac water collected from blowback. Various methods that have been successfully utilized to treat the frac water are shown in Table 1.

Clarification #1

In Stage I, hydrated lime is added to the raw water to raise the pH of the water to a very high alkaline level at which level many inorganic salts become insoluble and separate out. The addition of a coagulant such as polyaluminum chloride at this stage provides a curdling effect in the raw water thus separating out the insolubilized chelates, inorganic metal complexes, cross linkers, etc. The separation of solid from liquid at this stage is rapid and the solids quickly settle at the bottom.

Hydrated lime (calcium hydroxide Ca(OH)₂) and/or caustic soda (sodium hydroxide NaOH) are used to increase the pH to a level above about 9.0 and in certain cases above 11. At this high pH, the inter-molecular attractions between hydrocarbon and anionic poly-gels are disrupted and hydrocarbon particles along with surface-active poly-gels insolubilize and are adsorbed on a calcium carbonate suspension. Many inorganic salts become insoluble at this elevated pH and separate from solution. A highly cationic flocculant/coagulant/de-emulsifier such as polyaluminum chloride (Al Cl₃)ₙ i is introduced at this stage to agglomerate remaining suspended particles in combination with anionic poly-gels. Most of the metallic cross-linkers in the solution are also separated during this process. The reactions are dynamic so the propagation of this treatment requires careful pH monitoring and timely correction to maintain the preferred pH (preferably above 9). The solids settle rapidly. The flocculated material is separated by decantation or by filtration.

Acidification

The clarified liquid obtained after separating the flocculated material is acidified to reduce the pH to less than about 5.5 using a suitable inorganic acid. Hydrochloric acid is a preferred inorganic acid. This step eliminates excess alkalinity and releases cross-linked metallic ions.

Oxidation

The organic and metallic reducing agents released at the low pH of the acidification step are removed by an oxidation process. Strong oxidation agents with a suitable end point identification are utilized in this oxidation step. Potassium permanganate (KMₙO₄) is a preferred oxidizing agent. The sequence of the acidification and oxidation steps can be reversed in appropriate situations.

Clarification #2

In this second state, coagulants and/or flocculants are added to the liquid to agglomerate the metallic ions released by the oxidation step. The water is neutralized with a caustic/lime solution which promotes the formation of flocculant which can be separated easily by filtration or some other suitable process.

Polishing and Correction Treatment

Certain specialty chemicals and reducing agents can be introduced in this step to correct the liquid components to desired product specifications. A slow sand water filter can be utilized to polish the corrected water and remove remaining particles carried over from the clarifiers.

Reclaimed contaminated frac water varies in composition with the specific well site. The chemical consumption and sludge volume that is produced in each instance depends upon the fracturing chemicals that have been used. Chemical demand for frac water treatment is established for each batch separately. Approximately 15-30% vol. of sludge is produced during this process. The actual sludge volume varies with the specific frac-water composition. The sludge treatment and disposal procedure depends upon the location of the treatment facility.

Continuous Operation

Contaminated frac water is collected from various well sites and transported to a central treatment and disposal facility. Since composition of the frac water varies with fracturing treatment at the various well sites, stabilization of the frac-water blend is required for effective treatment. A minimum 48 hrs. holding capacity is usually necessary for smooth operation. Bench testing of the raw and treated water at intervals is essential for proper process monitoring and quality control. Bench and pilot scale testing is used to establish the design parameters for each treatment facility.

Referring to FIG. 1 in detail, FIG. 1 illustrates a flow sheet setting out a series of operations to treat reclaimed contaminated frac water so that it is converted to acceptable and reusable water. As illustrated in the flow sheet in FIG. 1, the spent frac water is subjected initially to a mechanical separation whereby solids are removed from the frac water by any suitable solid separation technique such as filtration. The solids, if deemed acceptable for recycling, are recycled to the process. Alternatively, if the solids are not acceptable, they are disposed to waste.

The liquid obtained from the solids-liquid mechanical separation process are hauled to a safe disposal site such as a frac water storage pond or tank. The frac water from the storage pond or tank is then treated with an alkaline agent to raise the pH above 9.0 to destabilize emulsified particles present in the liquid. Coagulants and/or flocculants are then introduced to promote floc formation and clarification. The flocculated sludge produced in his process is delivered to a conventional sludge de-watering process and subsequently to solid waste disposal.

The clarified water obtained after the initial flocculation procedure is then tested to see if the water is acceptable according to specifications for clarification. If the water is not acceptable, it is recycled to the frac water storage pond or tank for reprocessing. If the water is found to be acceptable after the initial flocculation clarification process, the pH of the water is reduced to less than about 5.5 and is then subjected to oxidation, followed by acidification, or in the alternative, acidification followed by oxidation. The water obtained from the acidification/oxidation or oxidation/acidification steps can then be subjected to a second clarification step. At that point, the water is treated with suitable coagulants and/or flocculants and neutralized. The flocculated solids are then delivered as sludge to a conventional sludge de-watering step and ultimately to solid waste disposal. Water that remains after the flocculated solids are removed is then tested according to specifications to see if the water is acceptable for delivery to reusable water storage. If the resultant water is not acceptable, it is subjected to appropriate corrective and polishing steps before being delivered to the reusable water storage-container.

When potassium permanganate is used as an oxidant, considerable bubbles are produced. The liquid also undergoes a colour change. Colour change indicates the oxidation level of the dissolved organics. This signifies a release of the soluble organics into an insoluble form. The complex break reaction that occurs at this pH level is a irreversible process. Formation of the coagulated mass can be observed. Lime is added to this stage to raise the pH of the water back to above at least 9 and even to about 11 or 12. Any inorganic metals that are trapped in the organic surfactant complex, which has been released due to the break up of the complex, are coagulated and settle. As a test, it may be noted that the lime requirement at this second stage is very low when compared to the lime requirement in stage I, indicating that the amount of inorganic contaminants is considerably less when compared to the first stage. When polyaluminum chloride is added again, the coagulated mass settles to the bottom. The pH of the water also becomes lowered to the required neutralised pH level.

Table 1 illustrates a number of alternative methods that can be used according to the invention to accommodate different frac water treatment conditions and requirements. In the case of Methods 1A and 1B, the first clarification step is identical except for the fact that the oxidation and acidification steps are reversed, according to required conditions. Clarification step #2in each case is similar in that acid neutralization is utilized before the polishing step.

Method 1C is similar to Method 1D except that in the first clarification step, the oxidation and acidification step are reversed. The second clarification steps are identical.

Methods 2A, 2B, 2C and 2D are simplified methods, compared to Methods 1A, 1B, 1C and 1D, in that only a first clarification step is utilized. This process can be used in cases where the reclaimed spent frac water is not particularly heavily contaminated. In Methods 2A and 2B, the respective first clarification steps are the same except that the oxidation and acidification steps are reversed. In Methods 2C and 2C, only a coagulation step, and no flocculation step, if followed. Again, in Methods 2C and 2D, the oxidation and acidification steps are reversed.

Methods 3A, 3B, 3C and 3D are similar to one another, and in a general sense, to the methods disclosed in Methods 2A, 2B, 2C and 2D. However, in Method 3A, a neutralization step rather than an acidification step is utilized in association with oxidation, neutralization and oxidation being reversed in each method. Methods 3C and 3D are similar to Methods 3A and 3B except there is no flocculation step. The second stage in all of Methods 3A, 3B, 3C and 3D involve a chemical correction step prior to the polishing step.

Lastly, Methods 4A and 4B both utilize only a first clarification step. In Method 4A, flocculation is utilized prior to neutralization and polishing, whereas in Method 4B, there is no flocculation step after coagulation, prior to neutralization and polishing.

TABLE 1
FRAC WATER TREATMENT METHODS

| | | Method - 1A | Method - 1B | Method - 1C | Method - 1D |
|---|---|---|---|---|---|
| Stage #1 | Step #1 | Clarification #1 | Clarification #1 | Clarification #1 | Clarification #1 |
| | | pH adjustment >9.0 | pH adjustment >9.0 | pH adjustment >9.0 | pH adjustment >9.0 |
| | | Coagulation | Coagulation | Coagulation | Coagulation |
| | | Flocculation | Flocculation | — | — |
| | Step #2 | Oxidation | Acidification | Oxidation | Acidification |
| | Step #3 | Acidification | Oxidation | Acidification | Oxidation |
| Stage #2 | Step #1 | Clarification #2 | Clarification #2 | Clarification #2 | Clarification #2 |
| | | Coagulant | Coagulant | Coagulant | Coagulant |
| | | Flocculation | Flocculation | Flocculation | Flocculation |
| | Step #2 | Acid Neutralization | Neutralization | Neutralization | Neutralization |
| | Step #3 | Polishing | Polishing | Polishing | Polishing |
| | | Method - 2A | Method - 2B | Method - 2C | Method - 2D |
| Stage #1 | Step #1 | Clarification #1 | Clarification #1 | Clarification #1 | Clarification #1 |
| | | pH adjustment >9.0 | pH adjustment >9.0 | pH adjustment >9.0 | pH adjustment >9.0 |
| | | Coagulation | Coagulation | Coagulation | Coagulation |
| | | Flocculation | Flocculation | — | — |
| | Step #2 | Oxidation | Acidification | Oxidation | Acidification |
| | Step #3 | Acidification | Oxidation | Acidification | Oxidation |
| Stage #2 | Step #1 | Polishing | Polishing | Polishing | Polishing |
| | | Method - 3A | Method - 3B | Method - 3C | Method - 3D |
| Stage #1 | Step #1 | Clarification #1 | Clarification #1 | Clarification #1 | Clarification #1 |
| | | pH adjustment >9.0 | pH adjustment >9.0 | pH adjustment >9.0 | pH adjustment >9.0 |
| | | Coagulation | Coagulation | Coagulation | Coagulation |
| | | Flocculation | Flocculation | — | — |
| | Step #2 | Neutralization | Oxidation | Neutralization | Oxidation |
| | Step #3 | Oxidation | Neutralization | Oxidation | Neutralization |
| Stage #2 | Step #1 | Chem. Correction | Chem. Correction | Chem. Correction | Chem. Correction |
| | Step #2 | Polishing | Polishing | Polishing | Polishing |

| | | Method - 4A | Method - 4B |
|---|---|---|---|
| Stage #1 | Step #1 | Oxidation | Oxidation |
| | Step #2 | Clarification #1 | Clarification #1 |
| | | pH adjustment >9.0 | pH adjustment >9.0 |
| | | Coagulation | Coagulation |
| | | Flocculation | — |
| | Step #3 | Neutralization | Neutralization |
| Stage #2 | Stage #2 | Polishing | Polishing |

As can be seen, the process according to the invention is versatile and can be successfully and readily adapted to accommodate a wide range of contaminated frac water obtained from various oil and gas wells.

The following charts illustrate data obtained from four tests performed by Maxxam Analytics Inc. on four different four cubic meter samples of frac water obtained from an operating oil/gas company in southern Alberta, using the applicants' water treatment process.

The first three pages of data for each of the four tests report physical parameters for raw untreated frac water blow back. The next three pages report physical parameters for the respective frac water samples after a single clarification step according to the process of the invention. The last three pages report physical parameters for the respective frag water samples after two clarification steps according to the invention. Of note in each of the four tests is the dramatic reduction in turbidity from four digit to two digit numbers after a single clarification step, and a reduction from two digits to single digit numbers after a second clarification step.

After a single clarification step, most of the toxins and all of the suspended solids had been removed and the water could safely be disposed of in Class 1 and Class 2 wastewater disposal wells without any danger of damaging the disposal well. The single clarification step water could also be disposed of in municipal wastewater treatment systems, land spreading or reused in another oilfield process.

After a second clarification step, all samples were considered recyclable for use in a new fracing process as determined by Halliburton Oil Field Services Laboratory in Red Deer, Alberta. The concentration of toxic substances and suspended solids had been reduced to negligible levels and reuse of this water for a variety of oilfield and other purposes was possible.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A method of treating reclaimed contaminated oil and well fracturing water comprising:
(a) passing the contaminated fracturing water containing solids and liquid through a separator to remove solids from the liquid;
(b) treating the fracturing water liquid with an alkaline agent to increase the pH of the liquid to a level above about 9;
(c) adding a coagulant to the fracturing water liquid to form an agglomerate and separating the agglomerate from the fracturing water liquid;
(d) reducing the pH of the fracturing water liquid to a level of less than about 5.5;
(e) adding an oxidizing agent to the fracturing water liquid to oxidize and insolubilize oxidizable impurities in the fracturing water liquid; and
(f) removing the insolubilized impurities from the liquid.

2. A method as claimed in claim 1 wherein the oxidation and acidification steps (d) and (e) are performed in reverse order.

3. A method as claimed in claim 1 wherein hydrated lime is added at step (b) to increase the pH of the fracturing water to a level of above about 9.

4. A method as claimed in claim 1 wherein the coagulant in step (c) is polyaluminum chloride.

5. A method as claimed in claim 1 wherein both a flocculating agent and a coagulant are added to the fracturing water liquid in step (c)).

6. A method as claimed in claim 1 wherein an inorganic acid is added to the fracturing water liquid at step (d) to reduce the pH to less than 5.5.

7. A method as claimed in claim 6 wherein the inorganic acid is hydrochloric acid.

8. A method as claimed in claim 1 wherein the insolubilized impurities in step (f) are removed by passing the liquid through a sand water filter or a sediment cartridge filter.

9. A method as claimed in claim 1 wherein the oxidation agent in step (e) is potassium permanganate.

10. A method as claimed in claim 1 wherein after step (c)) and before step (d), the liquid is neutralized by reducing the pH to about 7.0.

11. A method as claimed in claim 10 wherein the neutralization and oxidation steps (d) and (e) are performed in reverse order.

12. A method as claimed in claim 1 wherein the fracturing water liquid that remains after oxidized insolubilized impurities are removed in step (f) is subjected to a second clarification step which includes a second acidification step, followed by a second oxidation step.

13. A method as claimed in claim 12 wherein the acid used in the second acidification step is hydrochloric acid.

14. A method as claimed in claim 12 wherein the oxidizing agent used in the second oxidation step is potassium permanganate.

15. A method as claimed in claim 12 wherein a coagulant is added to the fracturing water liquid during the second clarification step.

16. A method as claimed in claim 13 wherein the coagulant is polyaluminum chloride.

17. A method as claimed in claim 15 wherein a flocculant is also added to the fracturing water liquid during the second clarification step.

18. A method as claimed in claim 17 wherein the fracturing water liquid from the second clarification step is neutralized before being reused as water.

19. A method as claimed in claim 18 wherein the water that is produced from the second clarification step is treated by being passed through a sand water filter or a sediment cartridge filter to remove remaining particles in the liquid.

20. A method of treating reclaimed contaminated fracturing water comprising: (a) passing the contaminated fracturing water containing solids and liquid through a mechanical separator to remove solids from the liquid; (b) treating the fracturing water liquid with a hydrated lime to increase the pH of the liquid to a level of above about 9; (c)) adding polyaluminum chloride to the fracturing water liquid to form an agglomerate and separating the agglomerate from the fracturing water liquid; (d) reducing the pH of the fracturing water liquid to a level of less than about 5.5 by adding hydrochloride acid to the liquid; (e) adding potassium permanganate to the fracturing water to oxidize and insolubilize oxidizable impurities in the fracturing water liquid; and (f) removing the insolubilized impurities from the liquid.
